(19) United States
(12) Patent Application Publication
(10) Pub. No.: US 2025/0029495 A1
(43) Pub. Date: Jan. 23, 2025

(54) Decision and control method for ADAS in preceding vehicle obstruction scene based on v2x

(71) Applicant: BEIJING NATIONAL NEW ENERGY VEHICLE TECHNOLOGY INNOVATION CENTER CO. , LTD., Beijing (CN)

(72) Inventors: Dinghai PAN, Beijing (CN); Yuan LI, Beijing (CN); Chengyin YUAN, Beijing (CN)

(21) Appl. No.: 18/714,729

(22) PCT Filed: Aug. 11, 2022
(86) PCT No.: PCT/CN2022/111851

§ 371 Date: May 30, 2024

(30) Foreign Application Priority Data
Jan. 26, 2022 (CN) 202210096454.8

(51) Int. Cl. G08G 1/16; B60Q 9/00; B60T 8/171; B60T 8/172; B60T 8/58; B60T 8/72; B60W 60/00

(52) U.S. Cl. CPC G08G 1/164; B60Q 9/00; B60T 8/171; B60T 8/172; B60T 8/58; B60T 8/72; B60W 60/001; G08G 1/166; B60T 2210/32; B60W 2554/802; B60W 2554/804; B60W 2556/45; B60W 2756/10

(57) ABSTRACT

A decision and control method for ADAS in a preceding vehicle obstruction scene based on V2X, ADAS system and intelligent networked vehicle, the decision and control method comprises: based on V2X perspective perception technology, collaboratively perceiving driving status information of an obstructed preceding vehicle, and fusing with driving status information of a potentially conflicting vehicle perceived by on-board perception of ego vehicle; based on the fused information, performing behavior judgment of the potentially conflicting vehicle; making a control decision of the ego vehicle according to judgment result. Through the application of V2X technology, the fusion of on-board perception technology and roadside perception technology is achieved, more accurate, more reliable and all-weather environmental perception information is obtained, and perception obstacles in key dangerous scenes are solved. In particular, in the scene where the line of sight to the preceding vehicle is obstructed, it realizes functions that traditional ADAS (based on on-board perception) cannot achieve or enhances the performance and reliability of traditional ADAS functions.

### FIELD OF TECHNOLOGY

The present disclosure relates to the field of autonomous driving technology, and particularly to a decision and control technology for an advanced driver assistance system (ADAS+) based on V2X perspective perception technology in a preceding vehicle obstruction scene, as well as an advanced driver assistance system (ADAS+) and a vehicle equipped with the system.

### BACKGROUND

Safe driving is the primary rigid demand of vehicle users. During driving, rear-end collision is a main factor causing traffic accidents. Especially on high ways or in other high-speed driving scenes, the vast majority of traffic accidents are caused by rear-end collisions, and often result in multi-vehicle pile-ups with serious casualties and losses. The causes are often following too closely or driver's inattention.

Although existing technologies attempt to solve this problem, such as Forward Collision Warning (FCW) and Automatic Emergency Braking (AEB), they are limited by physical factors and the system response is not timely, so these technologies are often still unable to avoid the occurrence of rear-end collisions. For example, an ego vehicle (SV) is following a preceding vehicle (TV2) at high speed, TV2 is following its preceding vehicle (TV1), and so on. If the frontmost vehicle TV1 performs an emergency braking due to a sudden situation, the adjacent preceding vehicle TV2 may subsequently also perform an emergency braking. The ego vehicle SV has to wait until the preceding TV2 shows an emergency braking for a certain time before the driver or the ADAS system can perceive and start to make judgments and reactions. If the vehicle spacing between SV-TV2-TV1 is relatively close, even if the ego vehicle SV is equipped with an ADAS system with AEB function, it may still be unable to avoid a rear-end collision with TV2. Most of the multi-vehicle pile-up accidents on highways occur in such scenes.

The integration of autonomous driving vehicles, roads, and smart cities is a current cross-industry development trend. The development and maturity of intelligent+connected+big data+cloud platform technologies are the technical foundation and guarantee for realizing “intelligent vehicles+”. Intelligent driving technology is one of the core technical fields of intelligent connected vehicles. Among them, environmental perception and control decision-making are the core technical bottlenecks of intelligent driving systems. At present, in the field of intelligent driving technology, the environmental perception capability of the system is far from mature, which is the bottleneck of bottlenecks and the key constraint to realize intelligent driving. Both on-board perception (vehicle-mounted sensors) and vehicle-road collaboration (V2X) have their limitations. Only the combination of the two can achieve a breakthrough and leap in intelligent perception technology, which is currently the most feasible systematic solution and technical route and direction for intelligent driving. In other words, to realize the environmental perception capability that empowers intelligent driving of vehicles. it is necessary to integrate vehicle-mounted sensors and vehicle-road collaborative information technology, thereby greatly enhancing the perception capability of vehicles and ultimately greatly enhancing the functionality, performance, and reliability of intelligent driving of vehicles. Meanwhile, after the popularization of vehicle-road collaboration applications, the cost of single-vehicle intelligent perception can be greatly reduced.

Developing intelligent connected vehicles based on vehicle-road collaboration and realizing intelligent driving technology to solve the problem of extremely complex and ever-changing scenes is a long road and process. Although realizing fully autonomous driving is the direction of development for intelligent connected vehicle technology, it is a long-term goal, and it will take a long time to achieve widespread commercial application. Market demand is the decisive factor in promoting technological progress and implementation. Recently, the industry has begun to form a consensus that solving the problems of driving safety, traffic congestion, and improving traffic efficiency in key dangerous scenes through V2X technology is the most important market rigid demand and the biggest pain point in traffic travel safety. This is a problem that needs to be gradually solved in the next few decades. In other words, solving the driving safety problem in key dangerous scenes is the current key goal and promotes the industrialization and implementation of technology.

ADAS (Advanced Driver Assistance System) is a typical driver assistance system for solving driving safety problems and is also the technical foundation for realizing autonomous driving. It has been developing rapidly recently and has a huge market. However, although ADAS system products have been applied in the market for many years, their technology is still far from mature, and the functionality and performance of ADAS are also severely limited by the perception capabilities of the system. Especially in some special dangerous scenes, ADAS cannot achieve effective collision avoidance. By using V2X technology, the vehicle-mounted system can achieve fusion perception with roadside perception information, breaking through the technical bottlenecks of the system in perception and decision-making algorithms in some high-risk scenes, and developing an ADAS+ system with expanded functions and enhanced performance.

Existing ADAS technology relies on its on-board perception devices and is limited by its environmental perception range and capabilities. In many key dangerous scenes, it cannot play a role. For example, scenes where vehicles merging at intersections obstruct the field of view, scenes where the preceding vehicle is obstructed, scenes where traffic lights are obstructed, scenes where red lights are run at intersections, etc. In these scenes, physical conditions determine that the ADAS system based on the vehicle's own on-board perception cannot effectively play the role of collision avoidance in case of sudden situations.

V2X technology can help overcome the environmental perception obstacles in the above scenes and systematically improve the vehicle's environmental perception capabilities. However, the current application of V2X technology mainly focuses on helping to realize autonomous driving technology, and the widespread commercial application and implementation of autonomous driving technology are still a long way off. It can be seen that the combination of V2X and ADAS systems has very broad potential and development space in both technology and commercial application implementation.

### SUMMARY

The purpose of the present disclosure is based on the systematic and in-depth fusion of V2X and on-board perception, to solve one of the high-risk scenes that traditional ADAS system technology cannot solve, and to develop enhanced and more reliable ADAS+ system functional decision and control algorithm technology.

According to one aspect of the present disclosure, a decision and control method for ADAS in a preceding vehicle obstruction scene based on V2X is provided, including:

based on V2X perspective perception technology, collaboratively perceiving driving status information of an obstructed preceding vehicle, and fusing with driving status information of a potentially conflicting vehicle perceived by on-board perception of an ego vehicle;

based on the fused information, performing behavior judgment of the potentially conflicting vehicle;

making a control decision of the ego vehicle according to the judgment result.

Further, the driving status information of the potentially conflicting vehicle can be obtained by achieving real-time V2V communication and information interaction with the potentially conflicting vehicle or by achieving real-time V2I communication and information interaction with roadside unit equipment through V2X perspective perception technology;

the driving status information of the obstructed preceding vehicle can be obtained by achieving real-time V2V communication and information interaction with the obstructed preceding vehicle, or by achieving real-time V2I communication and information interaction with roadside unit equipment through V2X perspective perception technology.

Further, the control decision includes early alerting, mild decelerating, and emergency braking.

Further, when D0₀₂<D0₀₂₋ₐₗₑᵣₜ, early alerting is initiated to a driver;

wherein, D0₀₂ is relative distance between the ego vehicle and the potentially conflicting vehicle, D0₀₂₋ₐₗₑᵣₜ is an early alerting distance, D0₀₂₋ₐₗₑᵣₜ=Dₛₜₒₚ−D2ₛₜₒₚ+Dₚᵣₑ₁, wherein Dₚᵣₑ₁ is a preset constant for early alerting in advance, Dₛₜₒₚ is travel distance for the ego vehicle to decelerate to stop, D2ₛₜₒₚ is travel distance for the potentially conflicting vehicle to decelerate to stop.

Further, if the potentially conflicting vehicle undergoes emergency braking and a distance from its preceding vehicle is less than a preset value, an early alerting is initiated to the driver.

Further, when D0₀₂<D0_{02-mild}, a mild decelerating control is initiated;

wherein, D0₀₂ is the relative distance between the ego vehicle and the potentially conflicting vehicle, D0_{02-mild} is a triggering distance for mild decelerating control, D0_{02-mild}=Dₛₜₒₚ−D2ₛₜₒₚ, Dₛₜₒₚ is travel distance for the ego vehicle to decelerate to stop, D2ₛₜₒₚ is travel distance for the potentially conflicting vehicle to decelerate to stop.

Further, a deceleration of the mild decelerating is adjusted in real-time according to relative distance and relative speed between the two vehicles;

when D0₀₂>D_{02-mild}+Dₚᵣₑ₂, decelerating is stopped, Dₚᵣₑ₂ is a preset constant.

Further, when the minimum value of the absolute value of the deceleration of the ego vehicle |aₘᵢₙ|>A_aeb, an emergency braking control is initiated, wherein A_aeb is a set value.

According to another aspect of the present disclosure, an advanced driver assistance system based on V2X perspective perception technology is provided, which can execute the above-mentioned decision and control method.

According to yet another aspect of the present disclosure, an intelligent networked vehicle is provided, comprising the above-mentioned advanced driver assistance system based on V2X perspective perception technology;

An on-board perception unit and a roadside perception unit, provide target object information in an obstructed area for the advanced driver assistance system through V2X association and fusion perception.

According to the present disclosure, through the application of V2X technology, the fusion of on-board perception technology and roadside perception technology is achieved, more accurate, more reliable, and all-weather environmental perception information is obtained, and the perception obstacles in key dangerous scenes are solved. Especially in the scene where the line of sight to the preceding vehicle is obstructed, it realizes functions that traditional ADAS (based on on-board perception) cannot achieve or enhances the performance and reliability of traditional ADAS functions.

The method of the present disclosure performs behavior judgment of potentially conflicting vehicle based on V2X perception information, thereby developing control decision algorithm technology for the ego vehicle. On the one hand, it comprehensively considers the requirements of comfort, safety, and collision avoidance, meanwhile is applicable to both ADAS and autonomous driving systems. Decision and control algorithm strategy for the vehicle of the present disclosure is calculated and optimized in real-time through vehicle motion trajectories.

Before initiating emergency braking, the method of the present disclosure can apply a braking pre-control strategy when necessary to improve system response speed, reduce braking delay, and improve collision avoidance performance.

### BRIEF DESCRIPTION OF THE DRAWINGS

The present disclosure will be described in more detail through the illustrative embodiments in combination with the drawings, in which the same reference numerals generally represent the same components in the illustrative embodiments of the present disclosure.

FIG. 1 is a schematic diagram of a vehicle driving and road scene.

FIG. 2 is a systematic information interaction diagram of an embodiment of the present disclosure.

FIG. 3 is a vehicle motion relationship diagram of an embodiment of the present disclosure.

FIG. 4 is a systematic perception information processing and control decision flow of an embodiment of the present disclosure.

### DESCRIPTION OF THE EMBODIMENTS

The preferred embodiments of the present disclosure will be described in more detail below with reference to the drawings. Although the preferred embodiments of the present disclosure are shown in the drawings, it should be understood that the present disclosure can be embodied in various forms and should not be limited by the embodiments set forth herein. Rather, these embodiments are provided to make the disclosure of the present disclosure more thorough and complete and to fully convey the scope of the present disclosure to those skilled in the art.

The related technical terms in the present disclosure are explained as follows.

V2X: Vehicle to Everything, information communication and interaction between vehicles and the outside world (X represents all things in the outside world, including: V2V, V2I, V2N, V2P, etc.).

V2V: Vehicle to Vehicle, information communication and interaction between vehicles and other vehicles.

V2I: Vehicle to Infrastructure, communication and information interaction between vehicles and surrounding roadside facilities.

V2N: Vehicle to Network, communication and information interaction between vehicles and telecommunication networks.

V2P: Vehicle to People, communication and information interaction between vehicles and other vehicles.

AEB: Automatic Emergency Braking.

There are many core technical bottlenecks to realize intelligent driving, among which environmental perception technology is the core of the cores and the constraint factor for the implementation of intelligent driving systems. The purpose of the present disclosure is to obtain the ego vehicle's perspective perception and advance perception capabilities of the environment through the fusion perception of on-board perception and V2X technology (V2V or V2I), predict the behavior of the preceding vehicle TV2 being followed, so that the ego vehicle can make judgments and reactions in advance, and achieve the purpose of avoiding collision with the preceding vehicle to the greatest extent. The present disclosure provides the prediction, judgment, and control decision technology of the preceding vehicle TV2's behavior in this scene.

The present disclosure provides a decision and control method for ADAS in a preceding vehicle obstruction scene based on V2X, including: based on V2X perspective perception technology, collaboratively perceiving driving status information of an obstructed preceding vehicle, and fusing with driving status information of a potentially conflicting vehicle perceived by on-board perception of an ego vehicle: based on the fused information, performing behavior judgment of the potentially conflicting vehicle; making a control decision of the ego vehicle according to the judgment result.

To facilitate understanding of the scheme and effect of the embodiment of the present disclosure, a specific application example is given below. Those skilled in the art should understand that this example is for the purpose of facilitating understanding of the present disclosure and is not intended to limit the present disclosure in any way.

As shown in FIG. 1, there are at least three vehicles driving in the same lane on the road, and the ego vehicle is SV. The ego vehicle follows the vehicle TV2 immediately ahead, and vehicle TV2 follows other preceding vehicles, such as TV1. The three vehicles are driving at a relatively high speed and with a relatively close spacing. For example, in a scene of driving on a highway or other roads with a higher speed limit.

The ego vehicle SV is equipped with an ADAS system with an emergency braking function (AEB), but the line of sight to vehicle TV1 is obstructed by TV2. If TV1 performs an emergency braking due to a sudden situation, TV2 will subsequently follow with an emergency braking, and SV may fail to respond in time to TV2's emergency braking and cause a rear-end collision. For example, in a multi-vehicle pile-up traffic accident on a highway. If SV can perceive the driving information such as the braking status of TV1 in advance, it can make judgments in advance and take necessary control measures in advance, such as early alerting, early decelerating, or early emergency braking, to achieve the purpose of avoiding collision with TV2.

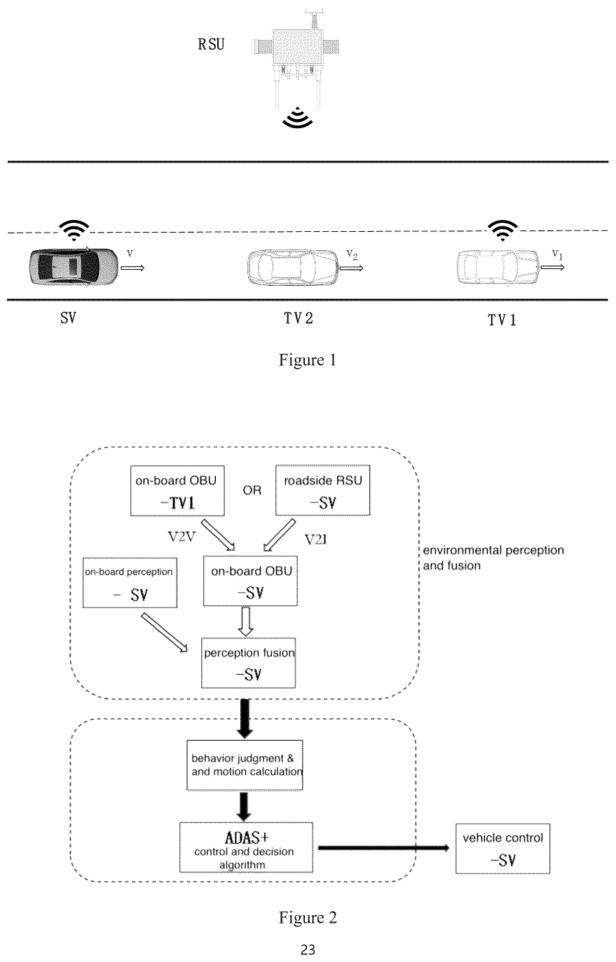

As shown in FIG. 2, the ego vehicle SV is equipped with perception devices such as visual cameras and millimeter-wave radar to identify the preceding targets (vehicles) and their positions, as well as the distance, driving speed (and deceleration) of the preceding targets.

The ego vehicle SV is equipped with an OBU (On Board Unit) device (V2X information communication equipment) for achieving real-time V2V communication and information interaction with the preceding vehicle TV2, or for achieving real-time V2I communication and information interaction with RSU (Road Side Unit) equipment.

The preceding vehicle TV1 is equipped with an OBU device to achieve real-time V2V communication and information interaction with the ego vehicle SV, which can transmit its driving speed, braking status, deceleration and other information to vehicle SV in real time.

Perception devices and RSU equipment for realizing V2I communication are installed on the roadside. Roadside perception can monitor and identify vehicles on the road in real time, as well as their position and status information (such as driving speed and deceleration, etc.). Vehicle SV realizes real-time information interaction with the roadside RSU equipment through V2I, and transmits information of TV1 to vehicle SV in real time.

In the present disclosure, the ego vehicle SV, through its on-board OBU device, through V2X (V2V or V21) communication, realizes docking with the preceding vehicle TV1 equipped with OBU device or the roadside RSU equipment, collaboratively perceives the driving status information of the obstructed preceding vehicle (such as TV1), and then fuses it with the on-board perception information of the ego vehicle. On the one hand, the ego vehicle perceives the driving status and distance of the vehicle TV2 immediately ahead through its own perception system, and at the same time, obtains the driving behavior information of vehicle TV1 in a timely manner through the perspective perception capability obtained through V2X. If the obstructed preceding vehicle TV1 decelerates or performs emergency braking. the system can obtain the decelerating information of the obstructed preceding vehicle in advance before the ego vehicle perceives the decelerating of the vehicle TV2 immediately ahead through on-board perception devices, make perception and judgment of the environment in advance, make decisions in advance, and take necessary measures in advance, such as alerting, active decelerating or emergency braking. The ultimate goal is to keep the ego vehicle SV at a safe driving distance from the vehicle TV2 immediately ahead and avoid collisions in emergency situations. To achieve the above system technical goals, the following aspects of technical content need to be mainly solved: real-time communication of V2V or V2I, perception fusion based on V2X, behavior prediction and behavior judgment of the preceding vehicle TV2, and control decision algorithm of SV.

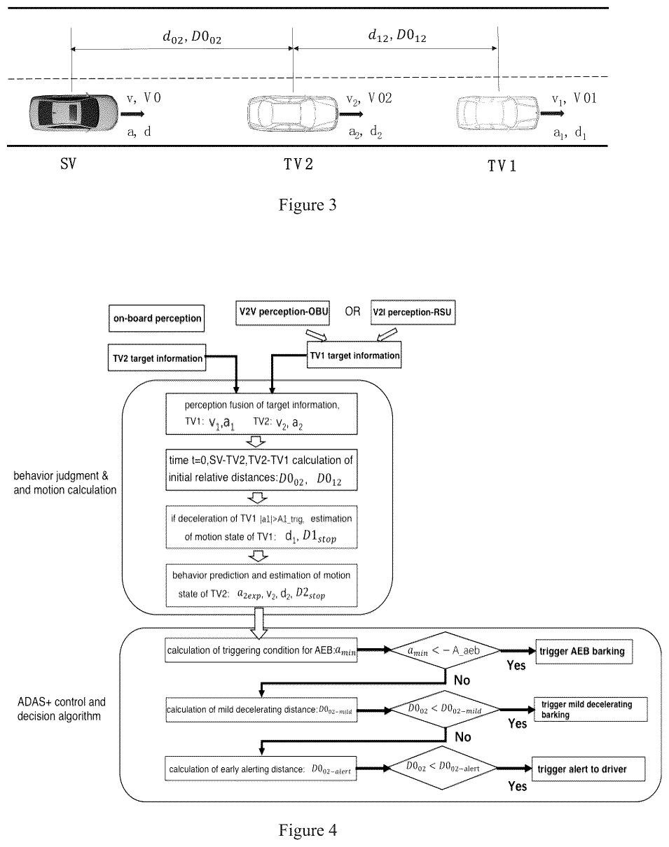

Referring to FIG. 3, the prediction and judgment for the driving behavior of the preceding vehicle TV2 and the control decision algorithm of SV in this embodiment are described.

### (1) The Prediction and Judgment for the Driving Behavior of TV2. Assumptions:

The instantaneous vehicle speeds of the ego vehicle SV, the vehicle TV2 immediately ahead, and the obstructed preceding vehicle TV1 are v, v₂ and v₁ respectively. The initial vehicle speeds at a certain initial calculation moment (t=0) are V, V02, V01 respectively.

The instantaneous vehicle distances between SV and TV2, TV2 and TV1 are d₀₂ and d₁₂ respectively. The initial vehicle distances at a certain initial calculation moment (t=0) are D0₀₂ and D0₁₂ respectively.

The instantaneous accelerations of SV, TV2, and TV1 are a, a₂ and a₁ respectively (note: deceleration is a negative value).

Under emergency braking, the shortest reaction time of the driver of the preceding vehicle TV2 is T_{dd2}, and the response delay time of the braking system is T_{bd2}.

The shortest reaction time of the driver of the ego vehicle SV is T_{dd}, and the response delay time of the SV braking system is T_{bd}.

In this disclosure, the main focus is on solving the problem that when TV2 follows TV1 and TV1 decelerates suddenly, the ego vehicle SV's perception system can obtain the perspective perception capability of TV1 through V2X technology, predict that TV2 may follow TV1 to enter emergency braking. The ego vehicle SV needs to judge TV2's decelerating behavior and estimate its driving trajectory in advance, thereby takes measures in advance to avoid rear-end collision with TV2 or reduce the severity of the collision to the greatest extent possible. If TV1 undergoes mild decelerating, it generally will not trigger the need for emergency braking of TV2 and SV, so this situation is not within the consideration scope of the present disclosure.

Wherein, prediction of the reaction behavior of the preceding vehicle TV2 (reaction delay and prediction of deceleration):

TV2 follows TV1 closely. When TV1 decelerates at high intensity (deceleration |a₁|>A1_trig, for example, A1_trig=0.5 g or other adapted values), TV2 will take decelerating behavior following TV1's decelerating, but with a delay from TV1. TV2's reaction behavior is aimed at avoiding collision with its preceding vehicle TV1, so it depends on the relative distance and relative speed between TV2 and TV1 and decelerating intensity of TV1.

From the current moment to a certain moment t, the motion state of TV1:

instantaneous speed of TV1: v₁=V₀₁+a₁*t

travel distance of TV1:

$${d}_{1} = \frac{2 * {V}_{01} + {a}_{{1}^{*}} t}{2} * t$$

when TV1 decelerates to stop, the required time is T1ₛₜₒₚ=−V₀₁/a₁, thus the travel distance of TV1 can be calculated from the above formula, defined as D1ₛₜₒₚ.

From the current moment to a certain moment t, the motion state of TV2:

instantaneous speed of TV2: v₂=V₀₂+a₂*(t−T_{dd2}−T_{bd2})

travel distance of TV2:

$${d}_{2} = {V}_{02} * ( {T}_{dd 2} + {T}_{bd 2} ) + \frac{2 * {V}_{02} + {a}_{2} * ( t - {T}_{dd 2} - {T}_{bd 2} )}{2} * ( t - {T}_{dd 2} - {T}_{bd 2} )$$

when TV2 decelerates to stop, the required time is T2ₛₜₒₚ=−V₀₂/a₂+(T_{dd2}+T_{bd2}), thus the travel distance of TV2 can be calculated from the above formula, defined as D2ₛₜₒₚ.

Relative distance between TV2 and TV1:

$${d}_{12} = D {0}_{12} + {d}_{1} - {d}_{2}$$

The condition for TV2 to avoid collision with TV1 is that when TV2 brakes to stop, d₁₂>0

that is: D0₁₂+D1ₛₜₒₚ−D2ₛₜₒₚ>0

Thus, from the above formula, the minimum expected deceleration that vehicle TV2 should take can be predicted, defined as a₂ₑₓₚ (acceleration is a negative value).

Wherein, prediction and estimation of the relative distance between the ego vehicle SV and the vehicle TV2 immediately ahead:

from the current moment to a certain moment t, the motion state of TV2:

when t<(T_{dd2}+T_{bd2}),

instantaneous speed of TV2: v₂=V₀₂+a_{2_1}*t (note: deceleration is a negative value in the formula)

travel distance of TV2:

$${d}_{2} = \frac{2 * {V}_{02} + {a}_{2 \_ 1} * t}{2} * t$$

where, a_{2_1} is the acceleration (deceleration is a negative value) of TV2 measured during this period.

After

$$t > ( {T}_{dd 2} + {T}_{bd 2} ) , {V}_{02 \_ 2} = {V}_{02} + {a}_{2 \_ 1} * ( {T}_{dd 2} + {T}_{bd 2} )$$

where, V_{02_2} is the speed at

$$t = ( {T}_{dd 2} + {T}_{bd 2} ) .$$

$${v}_{2} = {V}_{02 \_ 2} + {a}_{2 exp} * ( t - {T}_{dd 2} - {T}_{bd 2} )$$

travel distance of TV2: d₂=d_{2_1}+d_{2_2}

where,

$${d}_{2 \_ 1} = \frac{2 * {V}_{02} + {a}_{2 \_ 1} * ( {T}_{dd 2} + {T}_{bd 2} )}{2} * ( {T}_{dd 2} + {T}_{bd 2} )$$

$${d}_{2 \_ 2} = \frac{2 * {V}_{02 \_ 2} + {a}_{2 exp} * ( t - {T}_{dd 2} - {T}_{bd 2} )}{2} * ( t - {T}_{dd 2} - {T}_{bd 2} )$$

If the expected deceleration |a₂ₑₓₚ|<|a₂| (the actual deceleration of TV2 perceived), use the actual deceleration (a₂ₑₓₚ=a₂). That is, in the calculation, a₂ₑₓₚ=min (a₂, a₂ₑₓₚ).

The calculation of d_{2_2} is until v₂₌₀ (stop), that is,

$$t = T {2}_{stop} = - {V}_{02 \_ 2} / {a}_{2 exp} + ( {T}_{dd 2} + {T}_{bd 2} )$$

Under the status that the ego vehicle SV is in the driver's driving operation state, from the current moment to a certain moment t, the motion state of SV:

instantaneous speed of SV: v=V₀+a*(t−T_{dd}−T_{bd}) (note: deceleration is a negative value in the formula)

travel distance of SV:

$$d = {V}_{0} * ( {T}_{dd} + {T}_{bd} ) + \frac{2 * {V}_{0} + a * ( t - {T}_{dd} - {T}_{bd} )}{2} * ( t - {T}_{dd} - {T}_{bd} )$$

relative distance between SV and TV2:

$${d}_{02} = D {0}_{02} + d 2 - d$$

Referring to FIG. 4, the control decision algorithm of this embodiment is described.

### (a) Early Alerting of Decelerating of Preceding Vehicle.

When the distance between the ego vehicle SV and the preceding vehicle TV2 is less than a certain safe distance, or when the obstructed preceding vehicle TV1 performs an emergency braking and the distance between TV2 and TV1 is less than a set value, before the need to activate the ADAS emergency barking or automatic decelerating function, system of the ego vehicle SV first initiate an early alerting to its driver in advance, so that the driver can take necessary operations as early as possible to avoid collision.

Safe distance setting method: if the preceding vehicle performs an emergency braking to stop, the ego vehicle can safely stop under mild decelerating (for example, |a_{mild}|<0.2 g, this value can be adjusted and optimized as needed) without the risk of collision with the preceding vehicle TV2.

(i) Calculation of Early Alerting Distance D0₀₂₋ₐₗₑᵣₜ;

Initial vehicle speed of the ego vehicle is V0, deceleration is a (aₛᵥ₀), initial vehicle speed of the preceding vehicle is V02, and deceleration is a₂.

Initial distance between the two vehicles is D0₀₂, the reaction delay of the driver of the ego vehicle is T_{_dd}, and the response delay of the braking system: T_{_bd}.

Where, prediction of TV2 motion:

if the preceding vehicle TV1 or TV2 brakes sharply, predict the travel distance of the preceding vehicle TV2 to decelerate to stop:

time for TV2 to decelerate to stop:

$$T {2}_{stop} = - \frac{{V}_{02}}{{a}_{2 exp}}$$

(deceleration is a negative value)

$$D {2}_{stop} = \frac{{{V}_{02}}^{2}}{2 * \vert {a}_{2 exp} \vert}$$

(Where, the calculation method of a₂ₑₓₚ, see “prediction of the reaction behavior of the preceding vehicle TV2”)

Where, estimation of the motion of the ego vehicle SV (under the condition of mild braking, the control target):

time to decelerate to stop:

$${T}_{s t o p} = - \frac{{V}_{0}}{{a}_{mild}}$$

(wherein, for example a_{mild}=0.2 g or other appropriate values)

travel distance for SV to decelerate to stop:

$${D}_{stop} = \frac{{{V}_{0}}^{2}}{2 * \vert {a}_{m \dot{ι} l d} \vert} + ( {T}_{d d} + {T}_{bd} ) * {V}_{0}$$

wherein, estimation of the distance between the ego vehicle SV and the preceding vehicle TV2:

$${d}_{02} = D {0}_{02} + D {2}_{stop} - {D}_{stop}$$

The principle for triggering early alerting is that after a certain time of early alerting, mild braking to stop can still be performed without collision with the preceding vehicle.

The condition for not colliding with the preceding vehicle is: d₀₂>0, that is, D0₀₂>Dₛₜₒₚ−D2ₛₜₒₚ.

Based on the above calculation, the early alerting distance is set to: D0₀₂₋ₐₗₑᵣₜ=Dₛₜₒₚ−D2ₛₜₒₚ+Dₚᵣₑ₁.

Here, Dₚᵣₑ₁ is a preset constant for early alerting in advance (for example, 25 m, the specific value can be adjusted and optimized as needed).

### (ii) Early Alerting Triggering Conditions

Early alerting triggering condition 1:

when the initial relative distance D0₀₂ between SV and TV2 is less than D0₀₂₋ₐₗₑᵣₜ, the system of SV initiates an early alerting to the driver.

Additional early alerting triggering condition 2:

in addition to early alerting condition 1, if TV1 undergoes emergency braking with a deceleration |a1|>0.5 g, and the relative distance between TV2 and TV1 D0₁₂<D2₁₂₋ₐₗₑᵣₜ, the system of SV initiates an early alerting to the driver. (For example, D2₁₂₋ₐₗₑᵣₜ=25 m, the specific value can be adjusted and optimized as needed)

### (b) Mild Decelerating Control

After the early alerting for the decelerating of the preceding vehicle TV2 and TV1, before the need to initiate high-intensity decelerating, mild decelerating can be initiated according to the vehicle distance and relative speed to maintain the vehicle distance and improve vehicle driving comfort. This function is applicable to vehicles with autonomous driving functions (or automatic accelerating and decelerating functions), and is not set for vehicles driven by drivers.

### (i) Calculation of Triggering Distance of Mild Decelerating Control

Using the aforementioned method, calculate Dₛₜₒₚ and D0ₛₜₒₚ. The triggering distance of mild decelerating control is:

$$D {0}_{02 - mild} = {D}_{stop} - D {2}_{stop}$$

### (ii) Mild Decelerating Control

When D0₀₂<D0_{02-mild}, initiate mild decelerating control to maintain the safe distance between SV and TV2. The deceleration of mild decelerating, for example, |a_{mild}|<0.2 g, this value can be adjusted in real-time according to the relative distance and relative speed between the two vehicles.

When D0₀₂>D0_{02-mild}+Dₚᵣₑ₂, stop decelerating, Dₚᵣₑ₂ is a preset constant.

### (c) Emergency Braking Control (AEB)

Following control target principle: In the case of significantly decelerating of TV2 (for example, |a₂|>0.5 g), according to the relative distance and relative speed between SV and TV2, as well as the deceleration of the preceding TV2, judge the possibility of potential collision between SV and TV2, and the deceleration required for SV to avoid the collision. If SV needs strong decelerating (for example, acceleration |a|>0.5 g) to avoid collision with TV2, SV triggers emergency braking (|a|>0.5 g) to achieve the goal of avoiding collision with TV2 or reducing the severity of the collision.

When TV2 follows the obstructed preceding vehicle TV1 and has V2X conditions, when judging whether SV needs to initiate AEB braking, the V2V perspective perception capability can be used in this scene to perceive the status information of TV1 in advance, and predict in advance that TV2 may enter emergency braking following TV1 after a certain delay time. Then, based on the predictive calculation and judgment, the vehicle SV can take emergency measures in advance when necessary, and may even enter an emergency braking state before TV2.

AEB triggering judgment condition:

According to the calculation in the “prediction of the reaction behavior of the preceding vehicle TV2”, from the current moment to a certain moment t, the predicted distance between SV and TV2 is: d₀₂=D0₀₂+d₂−d.

When d₀₂=0, it is the collision point between the ego vehicle SV and the preceding vehicle TV2. The condition for SV not to collide with TV2 is that when SV decelerates to stop, d₀₂>0.

The time for vehicle SV to brake to stop is:

$${T}_{stop} = - \frac{V 0}{a} + {T}_{bd} .$$

That is, when t=Tₛₜₒₚ, d₀₂>0 is the condition to avoid collision. That is:

$$d < D {0}_{02} + {d}_{2}$$

$$d = {V}_{0} * ( {T}_{d d} + {T}_{bd} ) + \frac{2 * V 0 + a * ( t - {T}_{d d} - {T}_{bd} )}{2} * ( {T}_{stop} - {T}_{dd} - {T}_{bd} )$$

From the above two formulas, the minimum value |aₘᵢₙ| of the absolute value of the deceleration a of the ego vehicle SV can be calculated. If |aₘᵢₙ|>A_aeb (for example 0.5 g or other set value), that is, the AEB function is triggered.

In this embodiment, through V2X (V2I, V2V) technology, the fusion of on-board perception and roadside perception information is realized, more accurate, more reliable, and all-weather environmental perception information is obtained, and the perception obstacles in key dangerous scenes are solved. Based on V2X perception fusion technology, it serves the ADAS system to form an ADAS+ system, thereby obtaining enhanced functional and performance ADAS functional algorithm technology. The control decision functional algorithm technology of the present disclosure on one hand considers the requirements of comfort, safety, and collision avoidance, meanwhile is applicable to ADAS and autonomous driving systems. The decision and control algorithm strategy of the vehicle can be calculated and optimized in real-time through vehicle motion trajectories. Before initiating emergency braking, when necessary, a braking pre-control strategy can be applied to improve system response speed, reduce braking delay, and improve collision avoidance performance.

In addition, the present disclosure also provides an advanced driver assistance system based on V2X perspective perception technology, which can execute the decision and control method described in the above embodiments.

The present disclosure also provides an intelligent networked vehicle, including the advanced driver assistance system based on V2X perspective perception technology described in the above embodiments;

on-board perception unit and roadside perception unit, through V2X association and fusion perception, provide target object information in an obstructed area for the advanced driver assistance system.

Those skilled in the art should understand that the purpose of the above description of the embodiments of the present disclosure is only to illustrate and explain the present disclosure, and is not intended to limit the embodiments of the present disclosure described here in any way.

What has been described above are the preferred embodiments of the present disclosure, and the description is exemplary rather than exhaustive, and is not intended to limit the embodiments disclosed here. Under the premise of not deviating from the scope and spirit of the embodiments described, many modifications and changes are obvious to those skilled in the art.

1. A decision and control method for ADAS in a preceding vehicle obstruction scene based on V2X, comprising:
based on V2X perspective perception technology, collaboratively perceiving driving status information of an obstructed preceding vehicle, and fusing with driving status information of a potentially conflicting vehicle perceived by on-board perception of ego vehicle;
based on fused information, performing behavior judgment of the potentially conflicting vehicle;
making a control decision of the ego vehicle according to judgment result.

2. The decision and control method according to claim 1, wherein through V2X perspective perception technology achieving real-time V2V communication and information interaction with the potentially conflicting vehicle or achieving real-time V2I communication and information interaction with roadside unit equipment, to obtain the driving status information of the potentially conflicting vehicle;
through V2X perspective perception technology achieving real-time V2V communication and information interaction with the obstructed preceding vehicle, or achieving real-time V2I communication and information interaction with roadside unit equipment, to obtain the driving status information of the obstructed preceding vehicle.

3. The decision and control method according to claim 1, wherein the control decision includes early alerting, mild decelerating and emergency braking.

4. The decision and control method according to claim 3, wherein when D0₀₂<D0₀₂₋ₐₗₑᵣₜ, initiating an early alerting to a driver;
wherein, D0₀₂ is relative distance between the ego vehicle and the potentially conflicting vehicle, D0₀₂₋ₐₗₑᵣₜ is an early alerting distance, D0₀₂₋ₐₗₑᵣₜ=Dₛₜₒₚ−D2ₛₜₒₚ+Dₚᵣₑ₁, wherein Dₚᵣₑ₁ is a preset constant for early alerting in advance, Dₛₜₒₚ is travel distance for the ego vehicle to decelerate to stop, D2ₛₜₒₚ is travel distance for the potentially conflicting vehicle to decelerate to stop.

5. The decision and control method according to claim 3, wherein if the potentially conflicting vehicle undergoes emergency braking, and a distance from its preceding vehicle is less than a preset value, initiating an early alerting to a driver.

6. The decision and control method according to claim 3, wherein when D0₀₂<D0_{02-mild}, initiating a mild decelerating control;
wherein, D0₀₂ is relative distance between the ego vehicle and the potentially conflicting vehicle, D0_{02-mild} is triggering distance for the mild decelerating control, D0_{02-mild}=Dₛₜₒₚ−D2ₛₜₒₚ, Dₛₜₒₚ is travel distance for the ego vehicle to decelerate to stop, D2ₛₜₒₚ is travel distance for the potentially conflicting vehicle to decelerate to stop.

7. The decision and control method according to claim 6, wherein adjusting a deceleration of the mild decelerating in real time according to relative distance and relative speed between two vehicles;
when D0₀₂>D_{02-mild}+Dₚᵣₑ₂, stopping decelerating, Dₚᵣₑ₂ is a preset constant.

8. The decision and control method according to claim 3, wherein when a minimum value of an absolute value of a deceleration of the ego vehicle |aₘᵢₙ| is greater than A_aeb, initiating an emergency braking control, wherein A_aeb is a set value.

9. An advanced driver assistance system based on V2X perspective perception technology, which executes decision and control method according to claim 1.

10. An intelligent networked vehicle, wherein the intelligent networked vehicle comprises the advanced driver assistance system based on V2X perspective perception technology according to claim 9;
on-board perception unit and roadside perception unit, providing target object information in an obstructed area for the advanced driver assistance system through V2X association and fusion perception.
